(19) United States
(12) Patent Application Publication
(10) Pub. No.: US 2025/0359556 A1
(43) Pub. Date: Nov. 27, 2025

(54) USE OF AN EXTRACT OF AT LEAST ONE AGAROPHYTE RED ALGA AS A NEMATOCIDAL AGENT AND METHOD FOR CONTROLLING PHYTOPATHOGENIC NEMATODES

(71) Applicant: STE D'ETUDES ET D'EXPLOITATION D'ALGUES ET PRODUITS MARITIME, SETEXAM, KENITRA (MA)

(72) Inventors: Mohammed Rachid LEBBAR, RABAT (MA); Mohamed Salim LEBBAR, KENITRA (MA)

(21) Appl. No.: 19/219,772

(22) Filed: May 27, 2025

(30) Foreign Application Priority Data
May 27, 2024 (MA) 65973

(51) Int. Cl. A01N 65/03; A01N 25/02; A01P 5/00

(52) U.S. Cl. CPC A01N 65/03; A01N 25/02; A01P 5/00

(57) ABSTRACT

Use of an extract of at least one agarophyte red alga as a nematocidal agent and method for controlling phytopathogenic nematodes

Use of an aqueous liquid product resulting from extraction by an alkaline aqueous solution of at least one agarophyte red alga of the Gelidiaceae family, such as Gelidium sesquipedale, as an agent for controlling phytopathogenic nematodes. The extraction product is in particular the aqueous phase obtained by extracting the said at least one agarophyte red alga by an alkaline aqueous solution, followed by filtration to recover the said aqueous phase, which may then have been concentrated, dehydrated or freeze-dried, and then redissolved in water for application.

The present invention relates to the use of an extract of at least one agarophyte red alga to control plant-parasitic nematodes, i.e. phytopathogenic nematodes, in particular root-knot nematodes. It also relates to a method for controlling phytopathogenic nematodes.

Phytopathogenic nematodes are simple, multicellular animal organisms, usually consisting of around 1, 000 cells. They take the form of round, cylindrical and spindle-shaped, bilaterally symmetrical, unsegmented worms, but are taxonomically distinct from earthworms, wireworms or flatworms. Most are microscopic in size, measuring around 0.3 to 12 mm in length and 0.01 to 0.5 mm in diameter, so they are usually observed under a microscope or magnifying glass.

Phytopathogenic nematodes attack plants, among other things, through their roots. When the plant is perforated by its stylet, the nematode injects digestive enzymes produced by the salivary glands into the plant tissue, then sucks up the digestion product and discharges it into the intestine.

The symptoms of nematode attack on a plant's root system are the appearance of galls or nodules, root lesions, excessive branching and stunted roots, with damage noted on the tips. Root infection also leads to a slow decline of the entire plant, which tends to wither even in sufficiently moist soil.

To combat phytopathogenic nematodes, which reduce the quantity and yield of crops, farmers can use nematode-resistant cultivarsor natural nematode predators or pathogens. This is known as biological control.

We can also alternate nematode-sensitive crops with non-host crops, the difficulty being that some nematode species have very wide host ranges. This is called cultural control.

Fumigant or non-fumigant synthetic nematocidal pest control products are also generally very effective, but most of these products have been progressively banned because of their harmful side-effects on human health and the environment. This is chemical control.

In practice, we use a combination of these different methods.

The applicant company has now discovered that a particular extract of at least one agarophyte red alga of the Gelidiaceae family, such as Gelidium sesquipedale, which is a red alga notably found on the Moroccan coast, has excellent nematocidal activity.

The first object of the present invention is therefore the use of an aqueous liquid product resulting from extraction by an aqueous alkaline solution of at least one agarophyte red alga of the Gelidiaceae family as an agent for controlling phytopathogenic nematodes.

In particular, the at least one agarophyte red alga can be selected from Gelidiella acerosa, Gelidium amansii, Gelidium cartilagineum, Gelidium liatulum, Gelidium pacificum, Gelidium lingulatam, Gelidium sesquipedale and Gelidium pristoides.

In accordance with a particular embodiment, the extraction product is the aqueous phase obtained by extracting said at least one agarophyte red alga by an alkaline aqueous solution, followed by filtration to recover said aqueous phase, which may then have been concentrated, dehydrated or freeze-dried, and then redissolved in water for application.

In particular, extraction was carried out at room temperature, for 30 minutes-8 hours, said at least one agarophyte red alga having been employed at a rate of 600-900 kg in 10-20 m³ of alkaline aqueous solution.

In particular, an aqueous alkaline solution containing 0.1-20% by weight, preferably 1-5% by weight, of sodium hydroxide or potassium hydroxide was used for extraction.

The alkaline aqueous phase obtained after filtration may have been neutralized with an acid, in particular nitric acid, sulfuric acid or phosphoric acid.

The aqueous liquid extraction product is applied in particular by watering the plants to be protected or by adding it to the soil or substrate, in particular by watering, on which the plants to be protected are to be grown.

Another object of the present invention is a method for controlling phytopathogenic nematodes, characterized by the fact that the aqueous liquid extraction product as defined above is applied to the soil or substrate on which the plants to be protected are installed or on which the installation of the plants to be protected is envisaged.

The plants are chosen in particular from market garden plants such as tomatoes and melons, salad crops such as lettuce, spinach, beans, fruit trees such as banana trees, avocado trees, pear trees, apple trees and nectarine trees, ornamental plants, horticultural plants such as rosebushes, meadow plants and field crops.

The aqueous liquid extraction product is preferably applied diluted to 0.5 to 100 mL per 1000 L of water.

The aqueous liquid extraction product can be applied at a rate of 1 to 10 liters per hectare.

The liquid extraction product can be applied 1 to 7 times a week, in particular for 1 to 40 weeks.

The following examples illustrate the present invention without, however, limiting its scope.

### EXAMPLES 1 TO 4

Preparation of an Extract by Alkaline Treatment of Gelidium sesquipedale

800 kg of the red alga Gelidium sesquipedale were placed in 20 m³ of water.

Alkaline treatment was carried out by adding NaOH at 3% concentration by mass at room temperature and stirring for 2 hours.

This was followed by filtration through a 0.1 micron filter to recover the liquid part in a quantity of 19 m³.

This liquid product, named L1 (Example 1), has a basic pH.

Neutralized to pH 7 with sulfuric acid, this liquid product is designated L1SL (Example 2). This liquid product has also been neutralized with nitric acid, and is referred to as L1NL (Example 3). It has also been neutralized with phosphoric acid, and is designated L1PL (Example 4).

### EXAMPLE 5

### Dilution Procedure for Liquid Products L1, L1SL, L1NL and L1PL

We diluted L1, L1SL, L1NL and L1PL (neutralized with phosphoric acid) to 0.01, 0.1 and 0.2% in the quantities shown in the following Table 1.

Dilutions were made in 10 liters of water. This volume corresponds to the capacity of the backpack machine used for spraying.

TABLE 1

| | Volume of stock solution | |
|---|---|---|
| Concentration (%) | (concentrated) | Watering volume |
| 0.1 | 10 mL | 10 L |
| 0.2 | 20 mL | 10 L |
| 0.5 | 50 mL | 10 L |
| 1 | 100 mL | 10 L |

For 0.01% dilution in 10 L of water:
the stock solution (concentrated, starting solution) was stirred for 5 minutes to homogenize it in case decantation occurred;
we filled the treatment machine with 10 liters of irrigation water drawn from the well-whose pH and conductivity we measured-and added 10 mL of stock solution taken with the precision pipette, mixed before treatment.

During the treatment, we stirred before each watering to ensure a homogeneous solution.

### EXAMPLE 6

### Effect on Nematode Reduction of L1, L1SL, L1PL and L1NL at Different Concentrations

We conducted 10 comparative trials, each with 20 lettuces: 4 control lettuces watered with water, 4 lettuces watered with diluted L1 at 4 concentrations, 4 lettuces watered with L1SL at 4 concentrations, 4 lettuces watered with L1PL at 4 concentrations and 4 lettuces watered with L1NL at 4 concentrations.

At each watering, 40 mL of water or aqueous liquid extraction product was poured over each lettuce.

Watering was carried out once a week for 4 weeks.

After 30 days, we pulled up the lettuces and counted the number of galls on the roots.

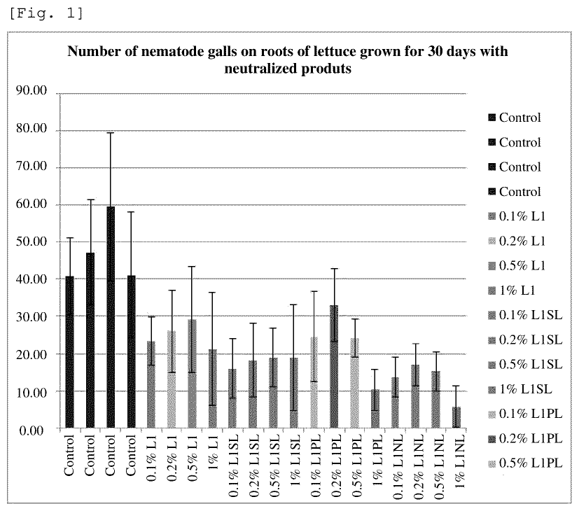

The results are summarized in Table 2 below and shown in schematic form in FIG. 1 of the appended drawing. It can be seen that all the liquid products of the invention have a nematode reduction activity as of their 1/1000 dilution.

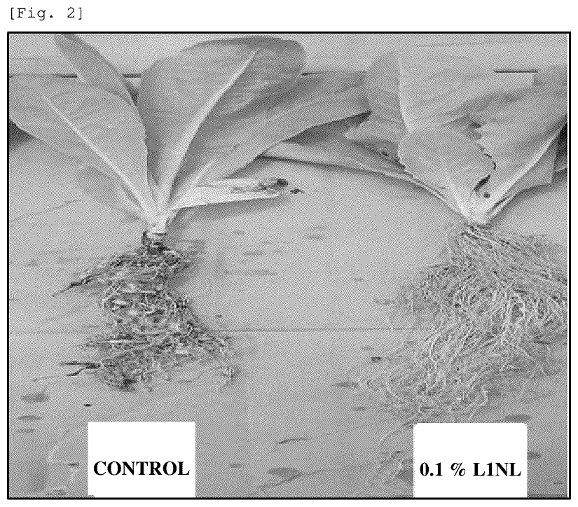

FIG. 2 of the attached drawing shows two photos of lettuces, one (left) untreated, and the other (right) treated with 0.1% L1NL under the above conditions after 30 days. Note that the black coloration of the roots, due to nematode infection, has disappeared in the case of the treated lettuce.

TABLE 2
Number of nematode galls on roots of lettuce
grown for 30 days with netralized products

| | | | | | | | | | | | | |
|---|---|---|---|---|---|---|---|---|---|---|---|---|
| 1% L1NL | 2 | 11 | 7 | 6 | 0 | 4 | 0 | 1 | 9 | 17 | 5.70 | 5.50 |
| 0.5% L1NL | 21 | 24.00 | 8.00 | 14 | 12 | 9 | 17 | 12 | 19 | 16 | 15.20 | 5.18 |
| 0.2% L1NL | 20 | 7 | 18 | 26 | 16 | 12 | 16 | 13 | 25 | 17 | 17.00 | 5.75 |
| 0.1% L1NL | 9 | 11 | 16 | 10 | 9 | 11 | 17 | 27 | 14 | 12.00 | 13.60 | 5.46 |
| 1% L1PL | 5 | 7 | 9 | 5 | 10 | 7 | 7 | 13 | 20 | 19 | 10.20 | 5.45 |
| 0.5% L1PL | 19 | 24 | 32 | 30 | 26 | 16 | 22 | 28 | 26 | 19 | 24.20 | 5.18 |
| 0.2% L1PL | 36 | 26 | 31 | 48 | 24 | 17 | 46 | 41 | 32 | 30 | 33.10 | 9.81 |
| 0.1% L1PL | 29 | 27 | 38 | 13 | 6 | 47 | 13 | 26 | 22 | 24.56 | 24.56 | 12.16 |
| 1% L1SL | 9 | 20 | 5 | 32 | 14 | 52 | 18 | 3 | 15 | 21 | 18.90 | 14.36 |
| 0.5% L1SL | 10 | 23 | 17 | 16 | 27 | 36 | 17 | 10 | 14 | 18.89 | 18.89 | 7.98 |
| 0.2% L1SL | 3 | 8 | 21 | 17 | 38 | 26 | 18 | 22 | 9 | 20 | 18.20 | 10.00 |
| 0.1% L1SL | 14 | 11 | 13 | 7 | 15 | 22 | 13 | 16 | 12 | 36 | 15.90 | 8.03 |
| 1% L1 | 5 | 29 | 17 | 24 | 10 | 2 | 35 | 46 | 7 | 37 | 21.20 | 15.27 |
| 0.5% L1 | 35 | 58 | 22 | 24 | 36 | 28 | 3 | 21 | 26 | 38 | 29.10 | 14.26 |
| 0.2% L1 | 29 | 32 | 43 | 36 | 19 | 8 | 19 | 36 | 24 | 14 | 26.00 | 11.08 |
| 0.1% L1 | 25 | 14 | 15 | 28 | 28 | 18 | 20 | 35 | 26 | 24 | 23.30 | 6.55 |
| Control | 30 | 69 | 54 | 20 | 48 | 38 | 14 | 55 | 36 | 48 | 41.20 | 16.90 |
| Control | 74 | 86 | 98 | 47 | 53 | 43 | 37 | 46 | 57 | 55 | 59.60 | 19.95 |
| Control | 54 | 39 | 34 | 41 | 48 | 26 | 42 | 68 | 71 | 49 | 47.20 | 14.16 |
| Control | 39 | 29 | 43 | 27 | 44 | 32 | 41 | 49 | 63 | 40.78 | 40.78 | 10.46 |
| Nbr Days | 30 | 30 | 30 | 30 | 30 | 30 | 30 | 30 | 30 | 30 | Average | Standard |

1.-12. (canceled)

13. A process for controlling phytopathogenic nematodes wherein an aqueous liquid product resulting from extraction by an aqueous alkaline solution of at least one agarophyte red alga of the Gelidiaceae family is applied to the soil or substrate on which the plants to be protected are installed or on which the installation of the plants to be protected is planned.

14. The process according to claim 13, wherein the at least one agarophyte red alga is selected from Gelidiella acerosa, Gelidium amansii, Gelidium cartilagineum, Gelidium liatulum, Gelidium pacificum, Gelidium lingulatam, Gelidium sesquipedale and Gelidium pristoides.

15. The process according to claim 13, wherein the extraction product is the aqueous phase obtained by extracting the at least one agarophyte red alga by an alkaline aqueous solution, followed by filtration to recover the aqueous phase.

16. The process according to claim 15, wherein the recovered aqueous phase was then concentrated, dehydrated or freeze-dried, then redissolved in water for application.

17. The process according to claim 15, wherein the extraction has been carried out at room temperature, for 30 minutes-8 hours, the at least one agarophyte red alga having been employed at a rate of 600-900 kg in 10-20 m³ of alkaline aqueous solution.

18. The process according to claim 15, wherein an aqueous alkaline solution containing 0.1-20% by weight of sodium hydroxide or potassium hydroxide was used for extraction.

19. The process according to claim 18, wherein the aqueous alkaline solution contains 1-5% by weight of sodium hydroxide or potassium hydroxide.

20. The process according to claim 15, wherein the alkaline aqueous phase obtained after filtration has been neutralized with an acid.

21. The process according to claim 20, wherein the acid is selected from nitric acid, sulfuric acid and phosphoric acid.

22. The process according to claim 13, wherein the aqueous liquid extraction product is applied by watering the plants to be protected or by adding by watering it to the soil or substrate on which the plants to be protected are to be grown.

23. The process according to claim 13, wherein the plants are chosen from market garden plants, salad crops, spinach, beans, fruit trees, ornamental plants, horticultural plants, meadow plants, field crops.

24. The process according to claim 23, wherein the market garden plants are chosen from tomatoes and melons.

25. The process according to claim 23, wherein the salad crops are chosen from lettuces.

26. The process according to claim 23, wherein the fruit trees are chosen from banana trees, avocado trees, pear trees, apple trees and nectarine trees.

27. The process according to claim 23, wherein the horticultural plants are chosen from rosebushes.

28. The process according to claim 13, wherein the aqueous liquid extraction product is applied diluted to 0.5 to 100 mL per 1000 L of water.

29. The process according to claim 13, wherein the aqueous liquid extraction product is applied at a rate of 1 to 10 liters per hectare.

30. The process according to claim 13, wherein the liquid extraction product is applied 1 to 7 times a week.

31. The process according to claim 30, wherein the liquid extraction product is applied for 1 to 40 weeks.
